(19) United States
(12) Patent Application Publication
(10) Pub. No.: US 2007/0108826 A1
(43) Pub. Date: May 17, 2007

(54) CLUTCH DEVICE FOR A SEAT LIFTING APPARATUS OF A VEHICLE

(75) Inventors: Yasuhiro Kojima, Kasiya-shi (JP); Yukifumi Yamada, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/559,074

(22) Filed: Nov. 13, 2006

(30) Foreign Application Priority Data
Nov. 17, 2005 (JP) 2005-333257

(51) Int. Cl. B60N 2/02

(52) U.S. Cl. 297/374

(57) ABSTRACT

A clutch device for a seat lifting apparatus of a vehicle includes a friction brake portion for transmitting rotation of an operational lever to an output shaft, an output gear provided at the output shaft, a biasing force receiving portion provided at the output shaft for receiving a biasing force which assists a rotation of the output shaft, a first bearing portion provided at one side of the biasing force receiving portion and the output gear and a second bearing portion provided at the other side of the biasing force receiving portion and the output gear. The first bearing portion and the second bearing portion rotatably support the output shaft at both sides of the biasing force receiving portion and the output gear.

### CROSS REFERENCE TO RELATED APPLICATIONS

This application is based on and claims priority under 35 U.S.C §119 with respect to Japanese Patent Application 2005-333257, filed on Nov. 17, 2005, the entire content of which is incorporated herein by reference.

### FIELD OF THE INVENTION

This invention relates to a seat lifting apparatus for adjusting height of a seat cushion for a vehicle seat.

### BACKGROUND

Conventionally, a vehicle seat is provided with a vehicle seat lifting apparatus for adjusting height of a seat cushion. In the seat lifting apparatus, height of the seat can be adjusted by operation of an operational lever while a passenger is sitting on the seat. An operational force reduction device using a repulsive force of a spring is provided to reduce the operation force.

In JP 4 (1992)-116233A, an operational force reduction device using a torsion bar and located in a parallel link type seat lifting apparatus is disclosed. In JP 62 (1987)-77247A, an operational force reduction device, which has a spiral spring coaxially arranged with a friction brake mechanism formed in an operating portion in a parallel link type seat lifting, is disclosed.

In the seat lifting apparatus disclosed in JP 4 (1992)-116233A, a deceleration device which increases an operational torque by reducing an operation speed of the operational lever to transmit the operational torque to the lifting mechanism is provided. The torsion bar is arranged to provide the biasing force to the lifting mechanism on the output side of the deceleration device.

Accordingly, a large torsion bar having a biasing force which is able to deal with weight of a passenger sitting on the seat is required. Consequently, a space for housing such large torsion bar is increased along with the increase in the cost.

In an operational force reduction device disclosed in JP 62 (1987)-77247A, an operational handle is connected to an input shaft and the spiral spring is disposed in the friction brake mechanism wherein a deceleration device is connected to an output shaft. Thus, it is possible to apply a biasing force of the spiral spring to an input side of the deceleration device. Therefore, the sufficient operational force reducing function can be attained even with a spiral spring which has a small biasing force.

However, a follower rotationally driven by an operational lever is rotatably supported at only an intermediate portion of the follower by a case and connected to the operational lever at one end. A torsion spring is disposed on the other end of the follower and further connected to the deceleration device at the other end.

For the structure, misalignment of a rotational shaft of the follower is likely to occur to deteriorate operational performance of the operational lever or to lower a brake ability. Further, with regard to assembly, the torsion spring and a driving member are needed to be housed in the case with both end portions of the spiral spring engaged with the case and the follower to accumulate the energy of the spring. Therefore, the assembly operation could be complicated.

The present invention has been made in view of the above circumstances, and provides a seat lifting apparatus which has an operational force reducing function and a clutch device which stably operates.

### SUMMARY OF THE INVENTION

According to an aspect of the present invention, a clutch device for a seat lifting apparatus of a vehicle includes a friction brake portion for transmitting rotation of an operational lever to an output shaft, an output gear provided at the output shaft, a biasing force receiving portion provided at the output shaft for receiving a biasing force which assists a rotation of the output shaft, a first bearing portion provided at one side of the biasing force receiving portion and the output gear, and a second bearing portion provided at the other side of the biasing force receiving portion and the output gear. The first bearing portion and the second bearing portion support the output shaft at both sides of the biasing force receiving portion and the output shaft.

### BRIEF DESCRIPTION OF THE DRAWINGS

The foregoing and additional features and characteristics of the present invention will become more apparent from the following detailed description considered with reference to the accompanying drawings, wherein:

FIG. 1 is a perspective view of a seat for a vehicle having a seat lifting apparatus of the vehicle;

FIG. 2 is a perspective view of a seat lifting apparatus;

FIG. 3 is a cross sectional view of a clutch device;

FIG. 4 is a front view of a spiral spring; and

FIG. 5 is an exploded perspective view of a main portion of the clutch device.

### DETAILED DESCRIPTION

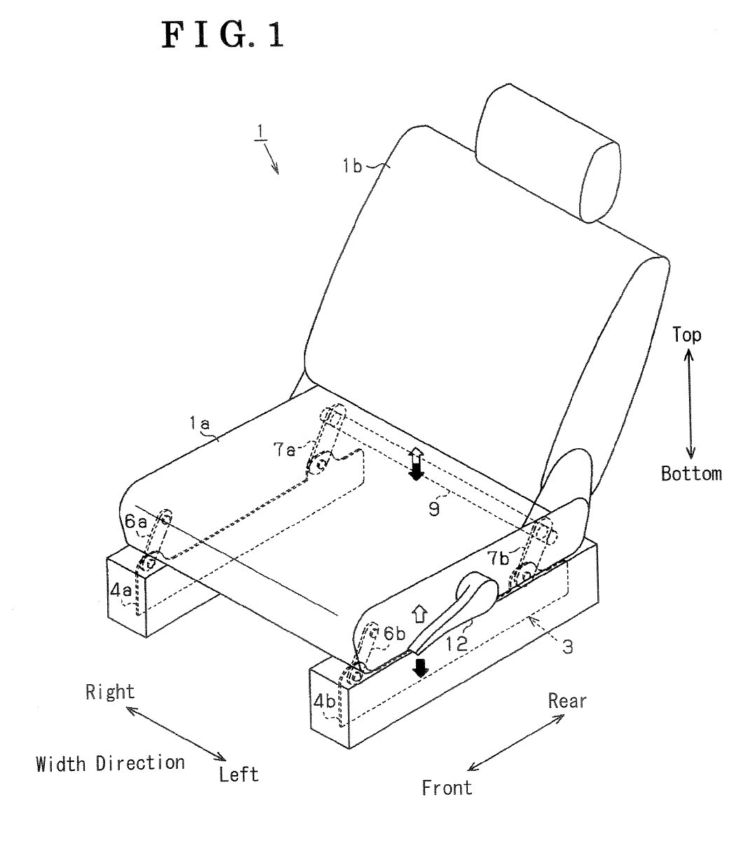

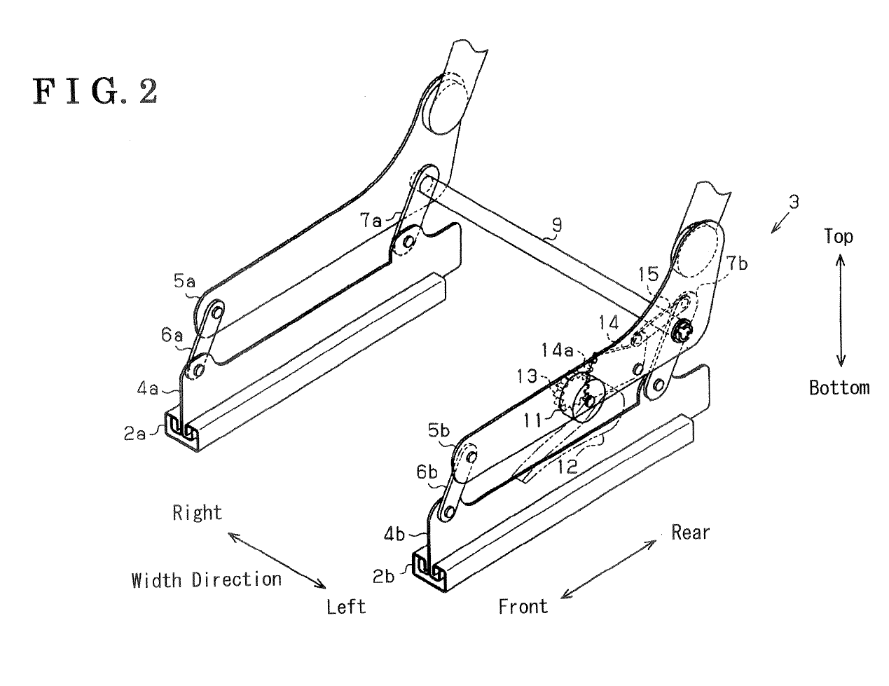

An embodiment of the present invention will be described below with reference to the attached drawings. A seat 1 illustrated in FIG. 1 and FIG. 2 is provided with a seat cushion 1a and a seat back 1b extending obliquely upward from an upper surface of a rear end portion of the seat cushion 1a and movably supported by a lower rail 2a and a lower rail 2b. The lower rail 2a and the lower rail 2b are fixed on a vehicle floor. A seat lifting apparatus 3 is mounted for adjusting height of a seating surface of the seat cushion l a at the lower end portion of the seat cushion 1a.

An upper rail 4a is slidably attached on the lower rail 2a and an upper rail 4b is silidably attached on the lower rail 2b. A base frame 5a of the seat cushion 1a is supported by the upper rail 4a and a base frame 5b of the seat cushion 1a is supported by the upper rail 5b so that the base frame 5a and the base frame 5b are able to move upward or downward.

In other words, a lower end portion of a lifer link 6a is rotatably supported by a front end portion of the upper rail 4a and a lower end portion of a lifter link 7a is supported by a rear end portion of the upper rail 4a. An upper end portion of the lifter link 6a is rotatably connected to a front end portion of the base frame 5a and an upper end portion 7a is rotatably connected to a rear end portion of the base frame 5a.

Similarly, a lower end portion of a lifter link 6b is rotatably supported by a front end portion of the upper rail 4b and a lower end portion of lifter link 7b is rotatably supported by a rear end portion of the upper rail 4b. An upper end portion of the lifter link 6b is rotatably connected by a front end portion of the base frame 5b and an upper end portion of the lifter link 7b is rotatably connected by a rear end portion of the base frame 5b.

A connecting portion between 7a and 5a is connected to a connecting portion between 7b and 5b by a cylindrical torque rod 9. Therefore, the base frame 5a and the base frame 5b can move upward and downward relative to each other.

A clutch device 11 is mounted on the base frame 5b and the operational lever 12 is mounted on the clutch device 11. An output shaft is formed with a pinion gear 13 and the pinion gear 13 rotates by the operation of the operational lever 12.

A proximal lower potion of a sector gear 14 is rotatably supported on a rear side of the clutch device 11 and teeth 14a is formed in a tip portion of the sector gear 14. The teeth 14a meshes the pinion gear 13 and the sector gear 14 rotates in response to rotation of the pinion 13.

A proximal upper portion of the sector gear 14 is connected to the upper end portion of the lifter link 7b by a driving link 15. The driving link 15 is rotatably connected to the sector gearl4 and the lifter link 7b.

Therefore, when the sector gear 14 rotates, the lifter link 7b rotates via the driving link 15 and the lifer link 7a rotates via the torque rod 9. Consequently, the base frame 5a and the base frame 5b move upward and downward relative to each other.

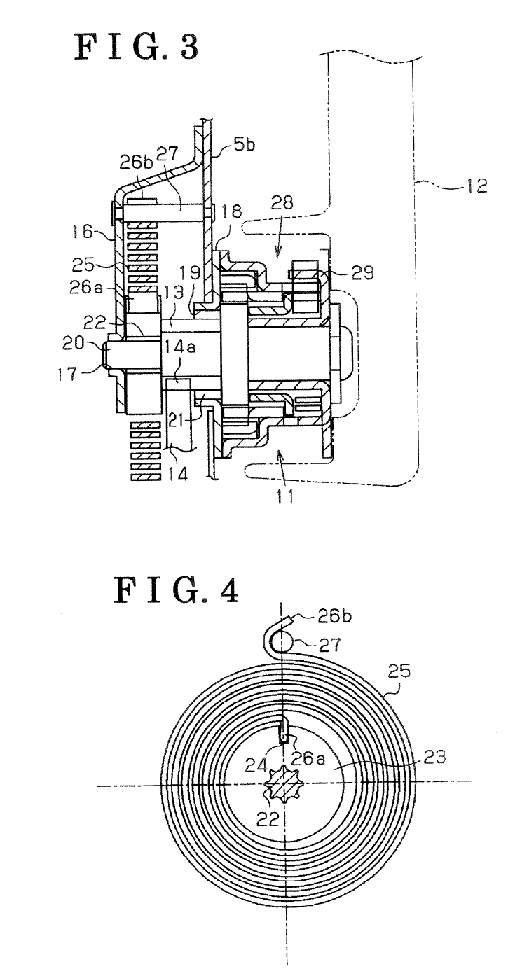

Next, the specific structure of clutch device 11 will be described. As illustrated in FIG.3, an auxiliary flame 16 is attached to the base frame 5b in the position where the clutch device 11 is supported. The auxiliary frame 16 is fixed to the base frame 5b at an proximal end portion, for example by bolts or other tools, and a tip portion of the auxiliary frame 16 extends in a way that the auxiliary frame 16 is positioned in parallel to the base frame 5b at a predetermined distance.

A through hole is formed in the tip portion of the auxiliary frame 16 to form a first bearing portion 17. A through hole is formed in the base frame 5b so that a central line of the through hole is aligned to a central line of the first bearing portion 17. The bearing member 18 is fitted into the through hole to form the second bearing portion 19. The diameter of the second bearing portion 19 is larger than the diameter of the first bearing portion 17.

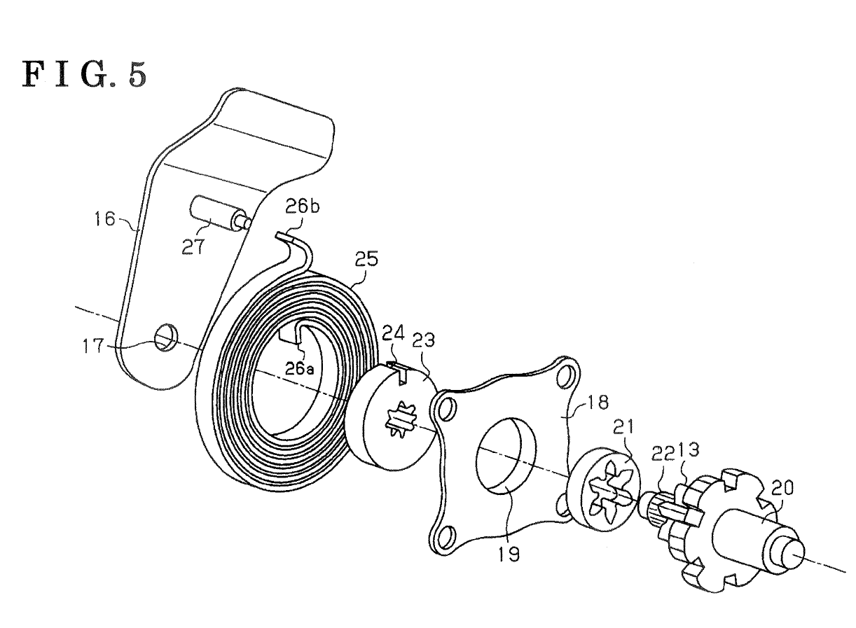

As illustrated in FIG. 5, the pinion gear 13 (the output gear) is provided at an intermediate portion of the output shaft 20 and the first bush 21 is unrotatably fitted into part of the pinion gear 13 relative to each other in the clutch device 11. Further, a tip portion of the output shaft 20 is formed with a diameter which allows the tip portion of the output shaft 20 to be inserted into the first bearing portion 17.

The intermediate portion of the output shaft 20 is rotatably supported by the second bearing portion 19 via the bush 21 and the tip portion of the output shaft 20 is rotatably supported by the first bearing portion 17. The teeth 14a of the sector gear 14 is meshed with a pinion gear 13 between the auxiliary frame 16 and the base frame 5b.

A spline 22 is formed by cutting the mark in the tip portion of the output shaft 20 on the side where the pinion gear 13 is positioned and a second bush 23 is unrotatably fitted into the spline 22 relative to each other. Therefore, the second bush 23 is fitted into the output shaft 20 so as to prevent a relative rotation between the output shaft 20 and the bush 23. An engaging groove 24 (biasing force receiving portion) is formed on an outer circumference surface of the second bush 23. That is to say, a biasing force receiving portion provided at the output shaft 20.

The spiral spring 25 is arranged around the second bush 23 and, as illustrated in FIG.4, an inner circumferential side end portion 26a of the spiral spring 25 is supported by an engaging groove 24. An outer circumferential side end portion 26b is supported by a supporting shaft 27 supported between the auxiliary frame 16 and the base frame 5b. Therefore, a biasing force of the spiral spring 25 provides a needed rotational torque to the output shaft 20 using a base frame 5b as a supporting point and the torque acts in a direction to move the base frame 5a and the base frame 5b upward. An engaging groove 24 receives the biasing force which assists a rotation of the output shaft 20.

One side of the output shaft 20 is projected to a side of the base frame 5b, and a friction brake portion 28 which is fixed to the base frame 5b is arranged therearound. The operational lever 12 engages a plate 29 which is rotatably supported by the proximal portion of the output shaft 20. The friction brake portion 28 transmits the rotation force of the plate 29 caused by the operation of the operational lever 12 to the output shaft 20. Hence, the friction brake portion 28 performs a known effect which blocks the rotation of the output shaft 20 by a rotation torque acting on the output shaft 20 from the sector gear 14 and the spiral spring 25.

In order to assemble the clutch device 11 described above, the friction brake portion 28 into which the output shaft 20 is fitted is fixed to the base frame 5b and the output shaft 20 is supported by the second bearing portion 19.

Subsequently, the second bush 23 and the spiral spring 25 are attached to the tip portion of the output shaft 20. Additionally, a proximal end portion of the auxiliary frame 16 is fixed to the base frame 5b with the tip portion of the output shaft fitted into the first bearing portion 17 of the auxiliary frame 16. The outer circumferential side end portion 26b of the spiral spring 25 is hung on the supporting shaft 27 and the plate 29 is rotated to adjust an initial torque of the spiral spring.

Next, operation of the seat lifting apparatus having the clutch device 11 described above will be described. When rotating the operational lever 12 in a direction which the seat is moved upwardly, the output shaft 20 is rotated via the friction brake portion 28 to rotate the sector gear 14.

In response to the rotation of the sector gear 14, the lifter link 7a and the lifter link 7b are rotated via the driving link 15. Consequently, the base frame 5a and the base frame 5b are moved upwardly. Thus, the seat cushion 1a is moved upward.

At this time, the biasing force of the spiral spring 25 acts in a direction which the biasing force assists the rotation of the output shaft 20. Therefore, the operational force of the operational lever 12 is reduced. On the other hand, when the operational lever 12 is rotated in a direction which the seat is moved downward, and the output shaft 20 is rotated via the friction brake portion 28 to rotate the sector gear 14.

In response to the rotation of the sector gear 14, the lifter link 7a and lifter link 7b are rotated via the driving link 15. Consequently, the base frame 5a and the base frame 5b are moved downward. Thus, the seat cushion 1a is moved downward.

At this time, the energy of the spiral spring 25 is accumulated in response to the rotation of the output shaft 20. Therefore, the seat cushion 1a is not quickly moved downward.

The clutch device 11 formed as described above can attain the following effects. (1) The output shaft 20 is supported by two portions which are the first bearing portion 17 and the second bearing portion 19. The pinion gear 13 of the output shaft 20 is meshed with the sector gear 14 between both bearing portions and the biasing force of the spiral spring 25 acts on the output shaft 20. Furthermore, the first bearing portion 17 and the second bearing portion 19 are positioned on both sides of the output shaft 20 in the axial direction relative to a meshing portion between the pinion gear 13 and the sector gear 14 and the biasing force receiving portion from the spiral spring 25. Thus, the occurrence of the shaft misalignment of the output shaft 20 caused by acting forces from the sector gear 14 and the spiral spring 25 can be prevented.

(2) The misalignment of the output 20 is restricted and this enables the friction brake 28 to operate stably.

(3) After fixing the friction brake portion 28 to the base frame 5b, the spiral spring 25 is attached to the output shaft 20. Subsequently, the auxiliary shaft 16 can be attached to the base frame 5b. Thus, the spiral spring 25 can be readily attached.

The embodiment described above may be changed as follows. The inner circumferential side end portion of the spiral spring 25 may be directly engaged with the output shaft 20.

Further, according to the invention, the seat lifting apparatus which has an operational force reducing function and a clutch device which stably operates can be provided.

The principles, of the preferred embodiment and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A clutch device for a seat lifting apparatus of a vehicle, comprising:
a friction brake portion for transmitting rotation of an operational lever to an output shaft;
an output gear provided at the output shaft;
a biasing force receiving portion provided at the output shaft for receiving a biasing force which assists a rotation of the output shaft;
a first bearing portion provided at one side of the biasing force receiving portion and the output gear; and
a second bearing portion provided at the other side of the biasing force receiving portion and the output gear, the first bearing portion and the second bearing portion rotatably supporting the output shaft at both sides of the biasing force receiving portion and the output gear.

2. A clutch device for a seat lifting apparatus of a vehicle according to claim 1, further comprising a base frame rotatably supporting the output shaft, an auxiliary frame attachable to the base frame and a spiral spring provided between the first bearing portion and the second bearing portion for supplying the biasing force to the output gear and the biasing force receiving portion, the first bearing portion and the second bearing portion being provided on the auxiliary frame and the base frame respectively.

3. A clutch device for a seat lifting apparatus of a vehicle according to claim 2, wherein the biasing force receiving portion includes a bush having an engaging groove, the bush is fitted into the output shaft so as to prevent a relative rotation between the output shaft and the bush and the engaging groove is able to be engaged with the one end of the spiral spring.

4. A clutch device for a seat lifting apparatus of a vehicle according to claim 2, further comprising a supporting shaft served as a supporting point of the biasing force generated by the spiral spring, the supporting shaft being arranged between the auxiliary frame and the base frame.
